(19) United States
(12) Patent Application Publication
(10) Pub. No.: US 2006/0182154 A1
(43) Pub. Date: Aug. 17, 2006

(54) Method of controlling laser oscillation of pulsed laser and pulsed laser system

(75) Inventors: Takuo Tanaka, Wako-shi (JP); Takayuki Hayashi, Wako-shi (JP); Satoshi Kawata, Wako-shi (JP)

Correspondence Address: BIRCH STEWART KOLASCH & BIRCH, PO BOX 747, FALLS CHURCH, VA, 22040-0747, US

(73) Assignee: RIKEN, Wako-shi (JP)

(21) Appl. No.: 11/330,223

(22) Filed: Jan. 12, 2006

(30) Foreign Application Priority Data
Jan. 13, 2005 (JP) 2005-006038

(51) Int. Cl. H01S 3/10

(52) U.S. Cl. 372/9; 372/25

(57) ABSTRACT

In order to perform positional control of a condensing spot of pulsed laser beam highly accurately when performing optical modeling, optical recording or the like in optical machining technology, optical recording technology or the like which uses various kinds of pulsed laser, which are ultra-short pulsed lasers such as a femtosecond laser and short pulsed laser such as a picosecond laser and a sub-picosecond laser, as a light source, a pulsed laser system detects an output beam from a pulsed laser, controls laser oscillation of the pulsed laser based on the detection result such the output beam contains CW laser beam together with pulsed laser beam, and allows the pulsed laser to output the pulsed laser beam and the CW laser beam simultaneously as the output beam from the pulsed laser.

### BACKGROUND OF THE INVENTION

1. Field of the Invention

The present invention relates to a method of controlling laser oscillation of a pulsed laser and a pulsed laser system, more particularly to a method of controlling laser oscillation of a pulsed laser and a pulsed laser system which are preferably used in ultra-short pulsed lasers such as a femtosecond laser and short pulsed lasers such as a picosecond laser and a sub-picosecond laser.

2. Description of the Related Art

In recent years, engineering development has been actively done where ultra-short pulsed lasers such as a femtosecond laser are used as a light source in optical recording technology such as an optical memory and optical machining technology such as optical modeling.

For example, Japanese Patent Laid-open No. 2003-1599 publication discloses a method where femtosecond laser beam output from a femtosecond laser is condensed in photo-curable resin to manufacture a three-dimensional micro-structure, Japanese Patent Laid-open No. 2003-211400 publication discloses a method of performing micromachining of nanometer level by using ultra-short pulsed laser, and Japanese Patent Laid-open No. 2001-216649 publication discloses a three-dimensional optical memory medium and its recording method where a condensing spot of ultra-short pulsed laser beam output from an ultra-short pulsed laser is moved three-dimensionally to record information three-dimensionally in a solid material containing light-emitting ion.

The above-described various methods are getting attention as methods of creating a micro-structure exceeding the limit of wavelength or directly creating a three-dimensional micro-object by using nonlinear optical effect.

However, engineering development regarding the positional control of the condensing spot of the ultra-short pulsed laser beam is not considered at all in the conventional methods, and there existed a problem of no method for detecting highly accurately where the condensing spot of the ultra-short laser beam is located on an object to be illuminated.

Specifically, in the optical machining technology and the optical recording technology using the ultra-short pulsed laser such as a conventional femtosecond laser, no consideration is taken for a method regarding the highly accurate positional control of the beam at all. As the present inventors investigated, articles, reports or patent applications which disclosed a method regarding the highly accurate positional control of the beam of the ultra-short pulsed laser beam could not be found.

On the other hand, in optical lithography technology or the like is known for controlling the positional relationship between a transferred image and a recording material in extremely high accuracy by using a laser interferometer or the like.

Further, an optical disc or the like uses an astigmatism method or a knife-edge method to constantly perform feedback control such that the condensing spot of laser beam follows a desired track.

However, in all of the technology, continuous wave laser beam output form a so-called continuous wave (CW) laser, from which beam is constantly output, is used for positional control of the condensing spot, and there existed a problem that performing the same positional control by using the ultra-short pulsed laser that emits light for a very short period of time was extremely difficult.

Specifically, although a method for controlling relative positional relationship between laser beam or an optical pattern and a processing object (including optical disc) by using various optical methods such as a laser interferometer and an astigmatism method is suggested in the engineering field of optical lithography and optical disc, the CW laser is used as a light source in these methods and the ultra-short pulsed laser has not been used directly as the light source for positional control.

Herein, the reason why the ultra-short pulsed laser cannot be used directly as the light source for positional control is that the ultra-short pulsed laser is a light source that emits light for only a short period of time on time axis as described above and positional information cannot be obtained continuously with such light source.

It is to be rioted that there exist Japanese Patent Laid-open No. 2003-1599 publication, Japanese Patent Laid-open No. 2003-211400 publication, and Japanese Patent Laid-open No. 2001-216649 publication, but they are not directly related to the present invention as prior art. According to the investigation of the present inventors, nothing is directly related to the present invention as prior art, neither of the publications of patent applications is directly related to the present invention, and the technology disclosed in each publication of patent applications will be significantly improved by using the present invention.

### OBJECTS AND SUMMARY OF THE INVENTION

The present invention has been created in view of the above-described various problems that the conventional art has, and it is an object of the invention to provide a method of controlling laser oscillation of a pulsed laser and a pulsed laser system, which are capable of performing highly accurate positional control of a condensing spot of pulsed laser beam when performing optical modeling, optical recording or the like in optical machining technology, optical recording technology or the like which uses various kinds of pulsed laser, which are ultra-short pulsed lasers such as a femtosecond laser and short pulsed laser such as a picosecond laser and a sub-picosecond laser, as a light source.

To achieve the above-described object, the present invention, contrarily to a regular method of controlling a pulsed laser, is that a pulsed laser is forcibly allowed to perform laser oscillation so as to contain pulsed laser beam and CW laser beam simultaneously as output beam that is output from the pulsed laser to make it possible to use the component of pulsed laser beam (hereinafter, appropriately referred to as “pulse component”) out of the output beam in the processing such as optical machining and optical recording, and to make it possible to use the component of CW laser beam (hereinafter, appropriately referred to as “CW component” or “direct-current component”) out of the output beam for the positional control of the condensing spot of the pulse component.

Specifically, the present invention is that various kinds of pulsed laser, which are ultra-short pulsed lasers such as a femtosecond laser and short pulsed laser such as a picosecond laser and a sub-picosecond laser, performs feedback control of laser oscillation so as to output the pulsed laser beam and the CW laser beam simultaneously, and is capable of performing positional control of the condensing spot of the pulse component by using the CW component while performing optical machining or optical recording by the pulse component.

Meanwhile, although the present inventors have not confirmed, a method where two lasers of ultra-short pulsed laser and CW laser are used and the lasers are coupled by an optical system to perform optical machining or optical recording and positional control may already exist.

In this method, however, it is necessary to align the condensing spots of the two lasers of ultra-short pulsed laser and CW laser on a sub-micron order, where it is an operation that generally requires extremely difficult and high technology, and there exists a problem that its practical use is extremely difficult.

On the other hand, according to the present invention, since the pulse component and the CW component are output from a single pulsed laser, their optical axes are completely matched in advance, and it exerts an excellent operational effect that there is no need to perform alignment by using an external adjusting means.

Furthermore, according to the present invention, since it is not necessary to perform positional control constantly, output beam from the pulsed laser may contain the CW component only for a certain period of time by utilizing blanking associated with luster scanning of a TV image, for example.

Specifically, the present invention is a method that includes the steps of: detecting output beam from a pulsed laser; controlling the laser oscillation of the pulsed laser based on the detection result such that the output beam contains pulsed laser beam and CW laser beam; and simultaneously outputting the pulsed laser beam and the CW laser beam as the output beam from the pulsed laser.

Further, the present invention is a system that includes: a pulsed laser that has a laser resonator that is constituted by having at least a pair of mirrors as a constituent member, and a laser medium arranged between the pair of mirrors of the laser resonator; detection means for detecting output beam from the pulsed laser; and control means for controlling the laser oscillation of the pulsed laser based on the detection result of the detection means such that the output beam contains pulsed laser beam and CW laser beam.

Further, in the present invention, the control means controls the position of at least one constituent member of the laser resonator.

Further, in the present invention, the control means controls the position of at least one mirror of the pair of mirrors of the laser resonator.

Further, in the present invention, the control means controls the external shape of at least one constituent member of the laser resonator.

Further, in the present invention, the control means controls the shape of the reflection surface of at least one mirror of the pair of mirrors of the laser resonator.

Furthermore, the present invention has amplification means for amplifying output beam from the laser resonator outside the laser resonator, and the control means controls the amplification means.

Further, the present invention has incidence means for making beam incident into the laser resonator outside the laser resonator, and the control means controls the incidence means.

Further, in the present invention, the control means changes the environment of the pulsed laser.

Still further, in the present invention, the pulsed laser is either an ultra-short pulsed laser or a short pulsed laser.

Consequently, according to the present invention, in optical machining technology, optical recording technology or the like which uses various kinds of pulsed lasers like ultra-short pulsed lasers such as a femtosecond laser and short pulsed lasers such as a picosecond laser and a sub-picosecond laser, an excellent effect is exerted that the positional control of the condensing spot of the laser can be performed with good accuracy when performing the optical machining, the optical recording or the like.

Then, the present invention is used in the optical machining technology, the optical recording technology or the like which uses various kinds of pulsed lasers like the ultra-short pulsed lasers such as the femtosecond laser and the short pulsed lasers such as the picosecond laser and the sub-picosecond laser.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a conceptual constitution exemplary view of a pulsed laser system according to the first embodiment of the present invention;

FIG. 2 is a conceptual constitution exemplary view showing an example of the detailed constitution of the laser resonator of an ultra-short pulsed laser;

FIG. 3 is a conceptual exemplary view for explaining the degree of freedom of constituent members of the laser resonator of the ultra-short pulsed laser;

FIG. 4 is a conceptual exemplary view for explaining the degree of freedom of constituent members of the laser resonator of the ultra-short pulsed laser;

FIG. 5 is a conceptual constitution exemplary view of a pulsed laser system according to the second embodiment of the present invention;

FIG. 6 is a conceptual exemplary view showing a case where the external shape of a mirror or the like used as the constituent member of the laser resonator;

FIG. 7 is a conceptual constitution exemplary view of a pulsed laser system according to the third embodiment of the present invention;

FIG. 8 is a conceptual constitution exemplary view of a pulsed laser system according to the fourth embodiment of the present invention; and

FIG. 9 is a conceptual constitution exemplary view of a pulsed laser system according to the fifth embodiment of the present invention.

### DETAILED DESCRIPTION OF THE PREFERRED EMBODIMENTS

In the following, description will be made in details for an embodiment example of the method of controlling laser oscillation of the pulsed laser and the pulsed laser system according to the present invention with reference to the attached drawings.

It is to be noted that description will be made for the method of controlling pulsed laser oscillation according to the present invention and the first embodiment to the fifth embodiment of the pulsed laser system, and the same reference numerals are applied for the same or equivalent constitutions in each embodiment in the following explanation and drawings and their duplicate explanation will be properly omitted.

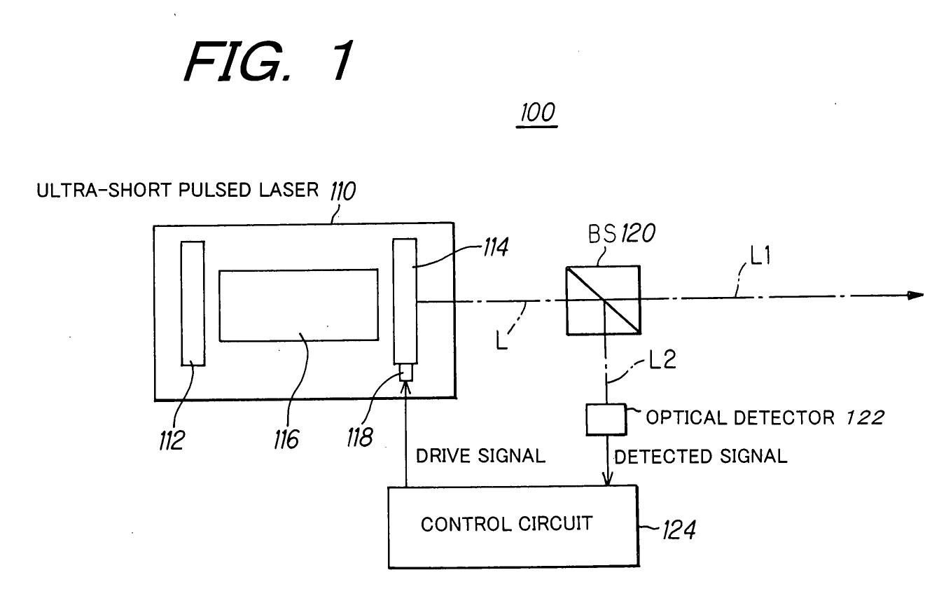

FIG. 1 is shows the conceptual constitution exemplary view of the pulsed laser system according to the first embodiment of the present invention.

The pulsed laser system 100 includes an ultra-short pulsed laser 110 such as a femtosecond laser, for example, which has a laser resonator that is constituted by having a pair or mirrors of an end mirror 112 and an output mirror 114, and a laser medium 116 arranged between the end mirror 112 and the output mirror 114 of the laser resonator.

Further, the pulsed laser system 100 also includes an actuator 118 that consists of a piezoelectric element, for example, which changes the position of the output mirror 114 such as an arranged position or tilt along an optical axis.

Furthermore, the pulsed laser system 100 includes a beam splitter (BS) 120 that splits output beam L from the ultra-short pulsed laser 110 into beams (L1, L2) of two optical paths, an optical detector 122 that detects the ratio between pulse component of beam L2 of one optical path, which has been split by the beam splitter 120, and CW component, and a control circuit 124 that controls the actuator 118 based on a detected signal indicating the detection result of the optical detector 120.

Herein, the control circuit 124 performs feedback control to the actuator 118 based on the detection result of the optical detector 120 to control laser oscillation such that the actuator 118 changes the position of the output mirror 114 and the detected signal indicating the detection result of the optical detector 120 always contains the CW component in addition to the pulse component at a predetermined ratio in the beam L2.

In the above-described construction, when the output beam L from the ultra-short pulsed laser 110, in the pulsed laser system 100, the output beam L is split into the beams (L1, L2) of two optical paths by the beam splitter 120.

The beam L1 being one of the beams split into two optical paths in this manner is used for optical machining, optical recording or the like in the optical machining technology, the optical recording technology or the like.

On the other hand, the beam L2 being the other one of the beams split into two optical paths is input to the optical detector 120, and the optical detector 120 detects the ratio between the pulse component and the CW component of beam L2, and outputs a detected signal indicating the detection result to the control circuit 124.

The control circuit 124, based on the detected signal output from the optical detector 120, performs feedback control for outputting a drive signal, which allows the actuator 118 to change the position of the output mirror 114, to the actuator 118 to control laser oscillation such that the detected signal always contains the CW component in addition to the pulse component at a predetermined ratio in the beam L2.

Then, the actuator 118 changes the position of the output mirror 114, that is, the arranged position or the tilt along the optical axis, for example, based on the drive signal that has been output from the control circuit 124 to allow the detected signal of the optical detector 122 to always contain the CW component in addition to the pulse component at a predetermined ratio in the beam L2.

Consequently, according to the pulsed laser system 100, the CW component is always contained in the beam L2, which is one of optical paths produced by splitting the output beam L from the ultra-short pulsed laser 110, in addition to the pulse component at a predetermined ratio, and the CW component is always contained in the beam L1, which is one of optical paths produced by splitting the output beam L from the ultra-short pulsed laser 110, in addition to the pulse component at the same predetermined ratio.

Specifically, with the above-describe control of laser oscillation, ultra-short pulsed laser beam and CW laser beam are simultaneously output as the output beam L from the ultra-short pulsed laser 110.

As a result, when using the beam L1 split from the output beam L for the optical machining, optical recording or the like in the optical machining technology, the optical recording technology or the like, the positional control of the condensing spot of the beam L1 containing the pulse component can be performed highly accurately using the CW component contained in the beam L1.

Meanwhile, the position of the output mirror 114 has been controlled in the above-described pulsed laser system 100, but it goes without saying that the invention is not limited to this. Instead of controlling the position of the output mirror 114 of the laser resonator, the position of the end mirror 112 of the laser resonator may be controlled by the same constitution to allow the detected signal of the optical detector 122 to always contain the CW component in addition to the pulse component in the beam L2 at a predetermined ratio. Further, instead of controlling either one position of the output mirror 114 and the end mirror 112 of the laser resonator, the positions of the both mirrors may be controlled to allow the detected signal of the optical detector 122 to always contain the CW component in addition to the pulse component in the beam L2 at a predetermined ratio. The point is that the position of at least one of the output mirror 114 and the end mirror 112 of the laser resonator may be controlled to allow the detected signal of the optical detector 122 to always contain the CW component in addition to the pulse component in the beam L2 at a predetermined ratio.

Furthermore, when the ultra-short pulsed laser 110 includes another mirror or prism as the constituent members of the laser resonator in addition to the pair or mirrors, which consists of the end mirror 112 and the output mirror 114, positional control that has been performed to the end mirror 112 or the output mirror 114 may be performed to at least one constituent member of the mirror and the prism to allow the detected signal of the optical detector 122 to always contain the CW component in addition to the pulse component in the beam L2 at a predetermined ratio.

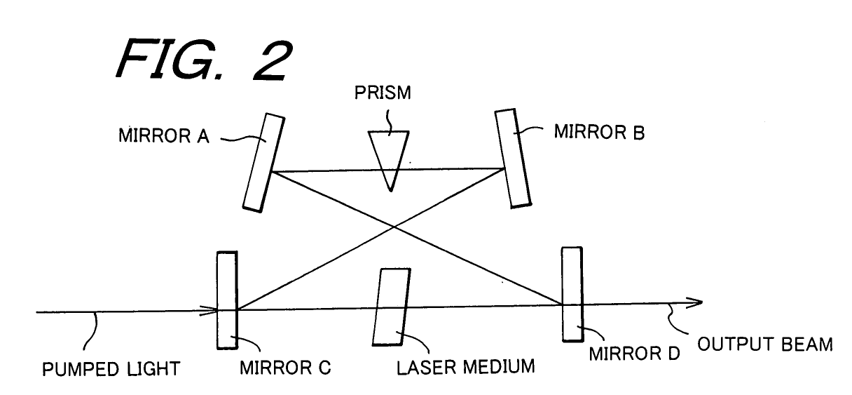

In the following, description will be made for an example of a specific controlling method when controlling the position of the constituent members that constitute the laser resonator of the ultra-short pulsed laser 110. To make understanding of the description easier, it is assumed that the laser resonator of the above-described ultra-short pulsed laser 110 have the constitution as shown in FIG. 2.

Specifically, the laser resonator shown in FIG. 2 includes mirror A, mirror B, mirror C, mirror D and a prism as its constituent members, a laser medium (corresponds to the laser medium 116 in FIG. 1) is arranged between mirror B and mirror C, and the prism is arranged between mirror A and mirror B.

Then, excited light is introduced into the laser resonator via mirror C, and mirror B corresponds to the end mirror 112 in FIG. 1, mirror D corresponds to the output mirror 114 in FIG. 1, and output beam (corresponds to output beam L in FIG. 1) is output from mirror D.

By controlling and changing the position of any one of mirror A, mirror B, mirror C, mirror D and the prism, which are the constituent members of the laser resonator shown in FIG. 2, that is, the arranged position or tilt along the optical axis, for example, the oscillation state of laser can be changed.

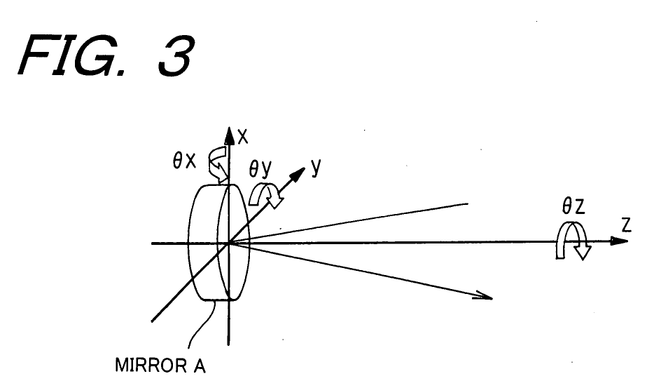

In other words, mirror A, mirror B, mirror C, mirror D and the prism have total six of degree of freedom, which are moving directions severally taken along x-axis, y-axis, z-axis, and rotation angles θx, θy, θz around each axis as parameters as shown in FIG. 3, when mirror A is shown as an example.

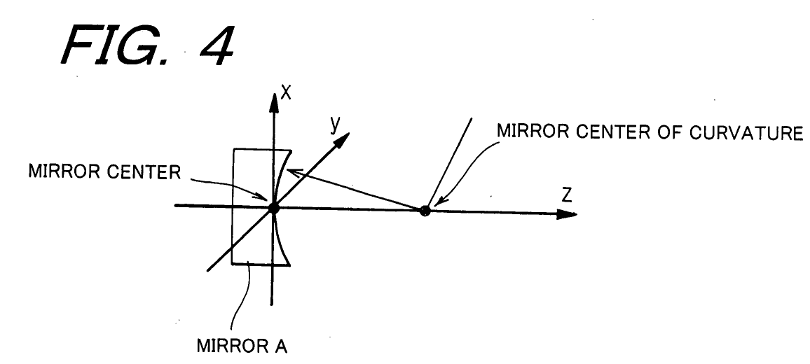

As shown in FIG. 4, x-axis, y-axis and z-axis are set such that z-axis is a straight line connecting the mirror center of mirror A and mirror center of curvature, and x-axis and y-axis include a point at which z-axis crosses mirror surface, are orthogonal to each other within a plane perpendicular to z-axis and an x-z plane matches a propagation plane of laser beam oscillating in the laser resonator.

Regarding one or a plurality of mirror A, mirror B, mirror C, mirror D and the prism, which have total six of degree of freedom as parameters, by controlling one or a plurality of parameters on a timely basis, desired control where the output beam always contains the CW component in addition to the pulse component at a predetermined ratio is realized.

In performing such control, each parameter to be controlled is not equal to each other but has the following characteristics.

(a) As a mirror used in the laser resonator such as mirror A, mirror B, mirror C and mirror D, a flat mirror or an axisymmetric mirror having concave plane or convex plane is generally used in most cases, so that influence to the laser resonator caused by the control of θz being rotation around z-axis is smaller than influence to the laser resonator caused by rotation of θx and θy.

(b) When the output end of laser beam, that is, the arranged position and tilt of a mirror (mirror D in FIG. 2) located at an output position of output beam are changed, the direction of output beam changes widely, which is not preferable generally. Therefore, it is desirable to make effort to avoid controlling a mirror located at the output end.

(c) In the case where the mirror such as mirror A, mirror B, mirror C and mirror D used in the laser resonator is the flat mirror, parallel translation Δy in y-axis direction is invalid when the rotation angle of θx is zero. Similarly, parallel translation Δx in x-axis direction is invalid when θy=0.

(d) When the propagation plane of beam under an oscillated state in the laser resonator is in x-z plane as shown in FIG. 3, controlling the beam in a direction to polarize it outside the propagation plane, that is, θy being the rotation around y-axis could disturb the oscillation state of the laser resonator to drastically reduce the intensity of output beam.

(e) When a parallel translation amount or rotation angle is small, that is, when Δx, Δy and Δz are several μm or less and θx, θy and θz are several 10 mrad or less, the following approximation expressions hold.
Δx≈θy+Δz
Δy≈θx+Δz

Next, description will be made for specific driving method of the mirror and the prism such as mirror A, mirror B, mirror C, mirror D and the prism.

Regarding the parallel translation Δx, Δy and Δz, the followings can be appropriately selected and used.

Driving by a piezoelectric element

Driving by an electric motor (for example, a linear motor, a stepping motor, a DC servo motor, an AC motor, etc.)

Driving by a voice coil

Driving by an electrostatic actuator

Further, regarding the tilt θx, θy and θz, the followings can be appropriately selected and used similar to the case of the parallel translation Δx, Δy and Δz.

Driving by a piezoelectric element

Driving by an electric motor (for example, a linear motor, a stepping motor, a DC servo motor, an AC motor, etc.)

Driving by a voice coil

Driving by an electrostatic actuator

Meanwhile, it is preferable that needless vibration or the like be occurred as low as possible in operating the actuator 118, and a small amount is enough for a specific drive amount. Consequently, a method of driving by a piezoelectric element is most effective out of the above-described various kinds of drive means.

Furthermore, as an actual control procedure, the mirrors and the prism may be controlled as described below. Specifically, in a femtosecond pulsed laser being the ultra-short pulsed laser, an optical element for correcting wavelength dispersion, for example, is installed in order to lock a plurality of modes oscillating in a wide band, that is, in order to create a so-called mode-lock state. For example, this element corresponds to the prism in FIG. 2 (in actual use, it is not a single prism but two or more of prism pairs), but in other cases, it is mirrors to which special coating is applied (which correspond to mirror A, mirror B, mirror C and mirror D in FIG. 2) which constitute the laser resonator.

Although controlling the above-described prism or specially coated mirrors is most effective in controlling the oscillation state of laser, there is a danger that the output intensity of output beam will be reduced drastically when the oscillation state is significantly changed. Then, in controlling the above-described prism or specially coated mirrors, it is preferable to control other mirrors so as to correct a reduced amount of the output intensity.

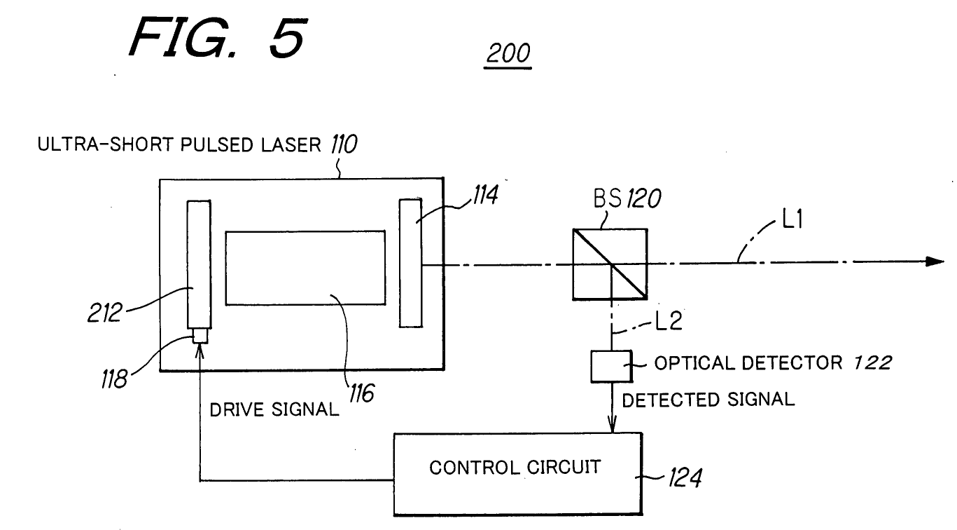

Next, FIG. 5 shows the conceptual constitution exemplary view of the pulsed laser system according to the second embodiment of the present invention.

The pulsed laser system 200 is different from the pulsed laser system 100 on the point that it uses a deformable mirror or the like which is capable of changing the external shape such as the radius of curvature on a reflection surface, for example, is used as an end mirror 212, and the actuator 118 controlled by a drive signal output from the control circuit 124 is disposed on the end mirror 212 in order to change the external shape such as the radius of curvature on the reflection surface of the end mirror 212.

It is to be noted that the deformable mirror is a mirror where the piezoelectric element or an array of electrostatic actuators is arranged on a mirror rear surface and which can directly control the external shape of the mirror by appropriately controlling them.

In the above-described construction, in the pulsed laser system 200, the control circuit 124 performs feedback control of outputting drive signals, which allow the actuator 118 to change the external shape of the end mirror 212, to the actuator 118 based on the detected signal output from the optical detector 120 such that the detected signal always contains the CW component in addition to the pulse component at a predetermined ratio in the beam L2, and controls laser oscillation.

Then, the actuator 118 changes the external shape of the end mirror 212, which is the radius of curvature, for example, based on the drive signal output from the control circuit 124 to allow the detected signal of the optical detector 122 to always contain the CW component in addition to the pulse component at a predetermined ratio in the beam L2.

Therefore, according to the pulsed laser system 200, the beam L2, which is one of optical paths produced by splitting the output beam L from the ultra-short pulsed laser 110, always contains the CW component in addition to the pulse component at a predetermined ratio, and the beam L1, which is the other one of optical paths produced by splitting the output beam L from the ultra-short pulsed laser 110, also contains the CW component in addition to the pulse component at a predetermined ratio same as the beam L2.

Specifically, by the above-described control of laser oscillation, the ultra-short pulsed laser beam and the CW laser beam are simultaneously output as the output beam L from the ultra-short pulsed laser 110.

For this reason, when using the beam L1 split from the output beam L in optical machining, optical recording or the like in the optical machining technology, the optical recording technology or the like, the positional control of the condensing spot of the beam L1 containing the pulse component can be performed with high accuracy by using the CW component contained in the beam L1.

Meanwhile, the external shape of the end mirror 212 of the laser resonator has been controlled in the above-described pulsed laser system 200, but it goes without saying that the invention is not limited to this. Instead of controlling the external shape of the end mirror 212 of the laser resonator, the external shape of the output mirror 114 of the laser resonator may be controlled on the same constitution to allow the detected signal of the optical detector 122 to always contain the CW component in addition to the pulse component at a predetermined ratio in the beam L2. Further, instead of controlling the external shape of either one of the end mirror 112 and output mirror 114 of the laser resonator, the both external shapes may be controlled to allow the detected signal of the optical detector 122 to always contain the CW component in addition to the pulse component at a predetermined ratio in the beam L2. The point is that the external shape of at least one of the end mirror 112 and output mirror 114 of the laser resonator may be controlled to allow the detected signal of the optical detector 122 to always contain the CW component in addition to the pulse component at a predetermined ratio in the beam L2.

Furthermore, when the ultra-short pulsed laser 110 includes another mirror or a prism as the constituent members of the laser resonator, for example, in addition to the pair of mirrors that consists of the end mirror 212 and the output mirror 114, the same control of the external shape performed to the end mirror 212 or the output mirror 114 may be performed to at least one constituent member of such mirror or prism to allow the detected signal of the optical detector 122 to always contain the CW component in addition to the pulse component at a predetermined ratio in the beam L2.

In the following, description will be made for an example of a specific control method in controlling the external shape of the constituent members that constitute the laser resonator of the above-described ultra-short pulsed laser 110.

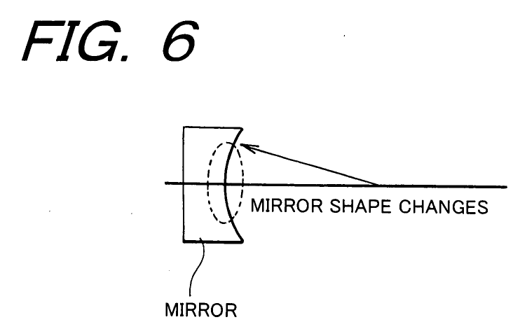

Specifically, as shown in FIG. 6, mode profile of laser beam propagating in the laser resonator can be controlled by changing the external shape of a mirror or the like that is used as a constituent member of the laser resonator, and thus the oscillation state of laser resonator can be controlled.

As a specific control method, it is possible to control the oscillation state by using the above-described deformable mirror or by using a linear motor, a piezoelectric element or the like to generate mechanical distortion in a constituent member that constitutes the laser resonator.

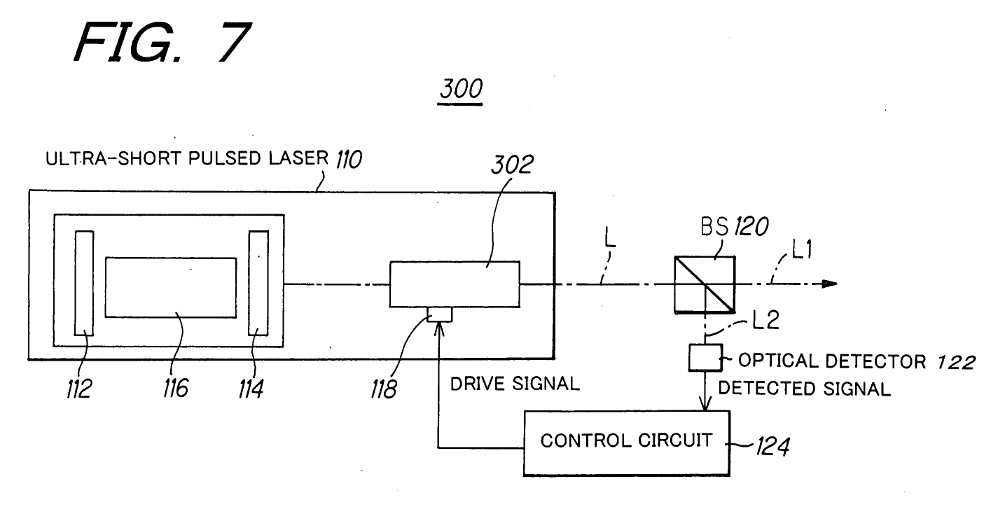

Next, FIG. 7 shows the conceptual constitution exemplary view of the pulsed laser system according to the third embodiment of the present invention.

The pulsed laser system 300 is different from the pulsed laser system 100 on the point that the ultra-short pulsed laser 110 includes an external resonator 302 as amplification means for amplifying the output beam from a laser resonator, which is constituted by having the pair of mirrors formed by the end mirror 112 and the output mirror 114, outside the laser resonator, and the actuator 118 controlled by drive signal output from the control circuit 124 is disposed on a mirror or a prism, which is a constituent member of the external resonator 302, in order to control the position or the external shape of the constituent member.

In the pulsed laser system 300, by controlling the external resonator 302 being the amplification means based on the drive signal output from the control circuit 124, that is, by controlling the position or the external shape of the mirror or the prism, which is the constituent member of the external resonator 302, it is possible to allow the detected signal of the optical detector 122 to always contain the CW component in addition to the pulse component at a predetermined ratio in the beam L2.

It is to be noted that the control of the position or the external shape of the mirror or the prism, which is the constituent member of the external resonator 302, by the actuator 118 is the same as the control in the pulsed laser system 100 or the pulsed laser system 200, so the detailed description will be omitted by incorporating the above-described description.

Further, as the amplification means in the pulsed laser system 300, there is a regenerative amplifier, an OPA (optical parametric amplifier), an OPO (optical parametric oscillator) or the like in addition to the above-described external resonator.

In controlling the regenerative amplifier, the OPA or the OPO, the position or the tilt of a mirror or a prism, which constitutes the optical system, may be controlled in the same manner as the case of the laser resonator.

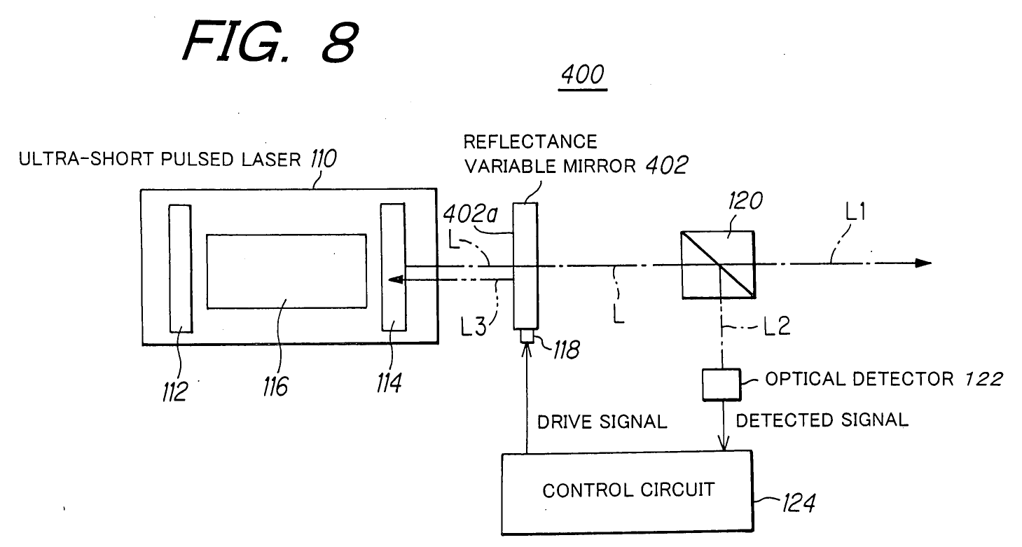

Next, FIG. 8 shows the conceptual constitution exemplary view of the pulsed laser system according to the fourth embodiment of the present invention.

The pulsed laser system 400 is different from the pulsed laser system 100 on the point that a reflectance variable mirror 402, where a reflecting film to make the reflectance variable is formed on a surface 402a facing the output mirror 114, is disposed between the output mirror 114 of the ultra-short pulsed laser 110 and the beam splitter 120, and the actuator 118 that is controlled by drive signal output from the control circuit 124 is disposed on the reflectance variable mirror 402 to control the reflectance of the reflectance variable mirror 402.

The reflectance variable mirror 402 functions as incidence means for making beam incident into the laser resonator of the ultra-short pulsed laser 110 from the outside.

In the pulsed laser system 400, by controlling the reflectance of the reflectance variable mirror 402 based on the drive signal output from the control circuit 124, that is, by changing the reflectance of the reflectance variable mirror 402 by the actuator 118 to control the intensity of the beam L3 of the output beam L, which is reflected by the reflectance variable mirror 402 to be returned into the laser resonator of the ultra-short pulsed laser 110, the detected signal of the optical detector 122 is allowed to always contain the CW component in addition to the pulse component at a predetermined ratio in the beam L2 by utilizing the influence that the beam L3 affects laser oscillation state.

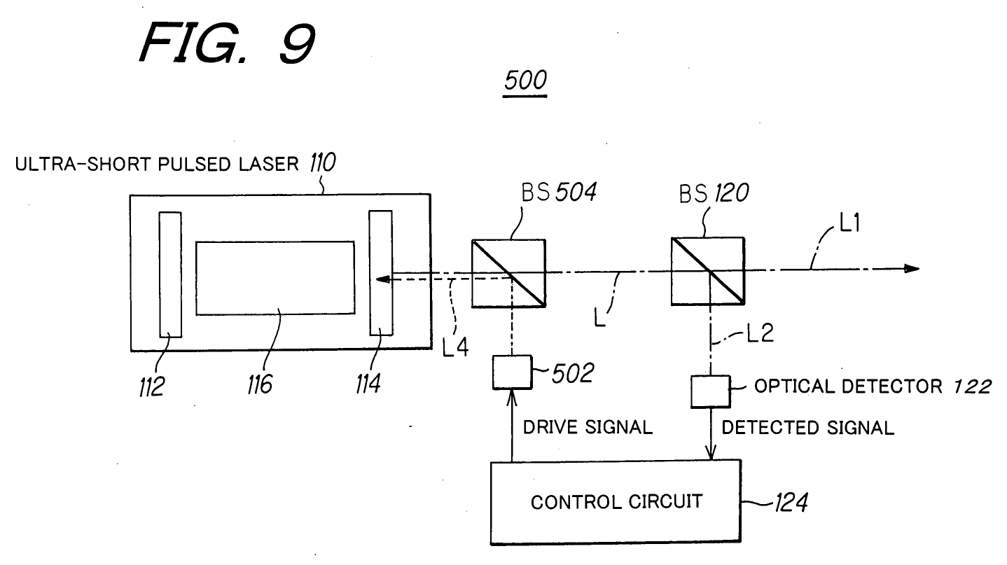

Next, FIG. 9 shows the conceptual constitution exemplary view of the pulsed laser system according to the fifth embodiment of the present invention.

The pulsed laser system 500 is different from the pulsed laser system 100 on the point that it includes a laser 502 whose output of output beam L4 is controlled by the drive signal output from the control circuit 124 and includes a beam splitter 504 that allows the beam L from the ultra-short pulsed laser 110 to transmit it and reflects the output beam L4 from the laser 502 to make incident into the laser resonator of the ultra-short pulsed laser 110. The laser 502 outputs laser beam, which has the same wavelength as that of the oscillation band of the ultra-short pulsed laser 110, as the output beam L4.

The laser 502 and the beam splitter 504 function as the incidence means for making beam incident into the laser resonator from the outside.

In the pulsed laser system 500, by controlling the output of the laser 502 based on the drive signal output from the control circuit 124, that is, by changing the output intensity, phase or intensity modulation state of the output beam L4 from the laser 502 to modulate the output beam L4 that is made incident into the laser resonator of the ultra-short pulsed laser 110 via the beam splitter 504, the detected signal of the optical detector 122 is allowed to always contain the CW component in addition to the pulse component at a predetermined ratio in the beam L2 by utilizing the influence that the beam L4 affects laser oscillation state.

Meanwhile, in the above-described pulsed laser system 500, the beam splitter 504 can be manufactured as a polarization beam splitter in order to improve use efficiency of light.

Incidentally, in the description of the above-described pulsed laser systems (100, 200, 300, 400, 500), detailed description was omitted for timing where the positional control of the condensing spot of the beam L1 is performed by using the CW component of the beam L1. For example, although it is necessary to perform positional control constantly when a recording object such as an optical disc moves in high-speed, constant positional control is not necessary in the case of an object such as a resist substrate used in optical lithography, which is often stationary. In such a case, using blanking timing of TV signals or the like to perform positional control only for a certain period is no problem.

Further, when it is not necessary to perform constant positional control as described, control by the control circuit 124 may be performed such that the output beam L contains the CW component synchronously with timing where positional control is needed.

Meanwhile, although the present inventors have not confirmed, the method as described above where the two lasers of the pulsed laser and the CW laser are used and the lasers are coupled by an optical system to perform optical machining or optical recording and positional control may already exist.

However, as shown in the following (1) to (3), the pulsed laser system according to the present invention has excellent effects that the method cannot achieve when the method and the pulsed laser system of the present invention are compared.

(1) Using the two lasers of the pulsed laser and the CW laser is disadvantageous in cost efficiency and in manufacturing the system in a smaller size. The pulsed laser system according to the present invention is extremely advantageous on this point because it can oscillate both pulsed beam and CW beam from one laser.

(2) When the two lasers of the pulsed laser and the CW laser are used as a light source, it is necessary to coaxially align the two laser beams output from the two lasers of the pulsed laser and the CW laser such that the condensing spot positions of the two laser beams match in the accuracy of sub-micron. However, coaxially aligning the two laser beams such that the positions match on the accuracy of sub-micron is extremely difficult and an operation requiring high technology. In addition, even if the two laser beams can be coaxially aligned, a problem that the beams will come off axis with passage of time is not negligible. Furthermore, the output direction of laser beam from the pulsed laser is not constantly fixed generally, but often sways at random temporally only by a little amount, so that it is virtually extremely difficult or impossible to coaxially align the two laser beams on such a condition. Since the pulsed laser system of the present invention can oscillate pulsed laser beam and CW laser beam from one laser, the pulsed laser beam and the CW laser beam are coaxially positioned.

(3) Generally, the constitution of laser resonator is often different depending on the pulsed laser or the CW laser, and a spread angle of laser beam output from the laser resonator is also different when the constitution of laser resonator is different. Under such circumstances, even if the problems of (1) and (2) are solved to adjust the laser beams coaxially, the spot positions of the two laser beams come off in an optical axis direction. Adjusting the positional shift is even more difficult than coaxially aligning the laser beams, and a complicate optical element for correcting the spread angle must be additionally prepared. On the other hand, in the pulsed laser system according to the present invention, since the two laser beam components of the pulsed laser beam and the CW laser beam are originally output from one laser resonator, the optical axis of the laser beam and the spread angle are completely matched previously, and thus it is not necessary to align them by using external adjusting means.

It is to be noted that the above-described embodiments can be modified as shown in (1) to (3) below.

(1) In the above-described embodiments, description was made for the femtosecond laser that is called the ultra-short pulsed laser as the pulsed laser. However, it goes without saying that the pulsed laser to which the present invention is applicable is not limited to the ultra-short pulsed laser, and the present invention is applicable for various kinds of pulsed laser such as a pulsed laser called as a so-called short pulsed laser.

(2) In the above-described embodiments, a constituent member of the laser resonator has been controlled or beam was made incident into the laser resonator from outside in controlling laser oscillation. However, it goes without saying that a method of controlling laser oscillation is not limited to this, and laser oscillation may be controlled by controlling the environment of the laser resonator or a laser medium inside the resonator, for example.

Specifically, an oscillating state of laser resonator can be changed by changing the environment of the laser resonator or a laser medium inside the resonator, by which laser oscillation can be controlled.

Herein, the environment means temperature, air pressure or the like, and it specifically means controlling the temperature or the air pressure inside the laser resonator or locally controlling the temperature of the constituent member of laser resonator such as a laser medium, a mirror and a prism.

Such temperature can be directly controlled by cooling or heating by a Peltier element or heating by a heater.

Further, the laser medium is usually cooled down forcibly by cooling water or a fan, and the same effect can be obtained by controlling the water temperature of the cooling water or controlling the rotation number of the fan.

(3) In the above-described embodiment, detailed explanation for the split ratio of beam in the beam splitters (120, 504) was omitted. It goes without saying that the beam splitters (120, 504) are not limited for ones that separate beam into “1:1”, that is, “50%:50%”, and the split ratio of beam in the beam splitters (120, 504) can be appropriately set. Specifically, the beam splitter 120 in the pulsed laser system 500 may take out an enough quantity of light that can be detected as the beam L2 by the optical detector 122, so that a beam splitter having the split ratio of “transmission:reflection=99%:1%” may be used, for example. Furthermore, the same applies to the beam splitter 504 in the pulsed laser system 500 as the case of the above-described beam splitter 120. Since the output beam L4 that is made incident to the ultra-short pulsed laser 110 may only have small intensity, the beam splitter 504 may be the one having the split ratio of “transmission:reflection=90%:10%”, for example, in order to prevent loss of the output beam L from the ultra-short pulsed laser 110.

(4) The above-described embodiment and the modification examples shown in (1) to (3) above may be appropriately combined.

It will be appreciated by those of ordinary skill in the art that the present invention can be embodied in other specific forms without departing from the spirit or essential characteristics thereof.

The presently disclosed embodiments are therefore considered in all respects to be illustrative an not restrictive. The scope of the invention is indicated by the appended claims rather than the foregoing description, and all changes that come within the meaning and range of equivalent thereof are intended to be embraced therein.

The entire disclosure of Japanese Patent Application No. 2005-006038 filed on Jan. 13, 2005 including specification, claims, drawings and summary are incorporated herein by reference in its entirety.

What is claimed is:

1. A method of controlling laser oscillation from a pulsed laser, said method comprising the steps of:
detecting output beam from a pulsed laser;
controlling the laser oscillation of said pulsed laser based on said detection result such that said output beam contains pulsed laser beam and CW laser beam; and
simultaneously outputting said pulsed laser beam and said CW laser beam as said output beam from said pulsed laser.

2. The method of controlling laser oscillation from a pulsed laser according to claim 1, wherein
said pulsed laser is any one of an ultra-short pulsed laser and a short pulsed laser.

3. A pulsed laser system, comprising:
a pulsed laser that has a laser resonator that is constituted by having at least a pair of mirrors as a constituent member, and a laser medium arranged between said pair of mirrors of said laser resonator;
detection means for detecting output beam from said pulsed laser; and
control means for controlling the laser oscillation of said pulsed laser based on the detection result of said detection means such that said output beam contains pulsed laser beam and CW laser beam.

4. The pulsed laser system according to claim 3, wherein
said control means controls the position of at least one constituent member of said laser resonator.

5. The pulsed laser system according to claim 3, wherein
said control means controls the position of at least one mirror of said pair of mirrors of said laser resonator.

6. The pulsed laser system according to claim 3, wherein
said control means controls the external shape of at least one constituent member of said laser resonator.

7. The pulsed laser system according to claim 3, wherein
said control means controls the shape of the reflection surface of at least one mirror of said pair of mirrors of said laser resonator.

8. The pulsed laser system according to claim 3, wherein
said system has amplification means for amplifying output beam from said laser resonator outside said laser resonator, and
said control means controls said amplification means.

9. The pulsed laser system according to claim 3, wherein
said system has incidence means for making beam incident into said laser resonator outside said laser resonator, and
said control means controls said incidence means.

10. The pulsed laser system according to claim 3, wherein
said control means changes the environment of said pulsed laser.

11. The pulsed laser system according to claim 3, wherein
said pulsed laser is any one of an ultra-short pulsed laser and a short pulsed laser.

12. The pulsed laser system according to claim 4, wherein
said pulsed laser is anyone of an ultra-short pulsed laser and a short pulsed laser.

13. The pulsed laser system according to claim 5, wherein
said pulsed laser is any one of an ultra-short pulsed laser and a short pulsed laser.

14. The pulsed laser system according to claim 6, wherein
said pulsed laser is any one of an ultra-short pulsed laser and a short pulsed laser.

15. The pulsed laser system according to claim 7, wherein
said pulsed laser is any one of an ultra-short pulsed laser and a short pulsed laser.

16. The pulsed laser system according to claim 8, wherein
said pulsed laser is any one of an ultra-short pulsed laser and a short pulsed laser.

17. The pulsed laser system according to claim 9, wherein
said pulsed laser is any one of an ultra-short pulsed laser and a short pulsed laser.

18. The pulsed laser system according to claim 10, wherein
said pulsed laser is any one of an ultra-short pulsed laser and a short pulsed laser.
